(19) United States
(12) Patent Application Publication
(10) Pub. No.: US 2008/0208612 A1
(43) Pub. Date: Aug. 28, 2008

(54) Method to develop new high net worth prospects and clients, and to maintain and manage clients and their business derived from the global equestrian community in a cost efficient and competitively enhanced manner for the financial institution

(76) Inventor: James Whisenand, Miami, FL (US)

Correspondence Address: JAMES D. WHISENAND, SUITE 602, 501 BRICKELL KEY DRIVE, MIAMI, FL, 33131, US

(21) Appl. No.: 12/079,044

(22) Filed: Mar. 24, 2008

(51) Int. Cl. G06Q 99/00

(52) U.S. Cl. 705/1

(57) ABSTRACT

A method to identify and to access in a meaningful manner qualified prospects—clients derived from the Global Equestrian Community for global financial institutions offering private banking-wealth management services and other financial advisory services in a manner that reduces or minimizes the cost and inefficiency of new prospect—client development in an effective manner by creating a participating peer status and/or insider status for the global financial institution via a participating intermediary in the Global Equestrian Community which is premised on polo team sponsorship and/or the sponsorship of high level equestrian participants in select global events/venues and to reduce the cost and efficiency of new prospect—client development and management of their business in a tripartite effective manner oriented to the Global Equestrian Community.

### CROSS-REFERENCE TO RELATED APPLICATIONS

(This Application is not based on any other patent known to Applicant).

Title: System and method for providing financial services to high net worth individuals.

U.S. application Ser. No. 09/520,763

Filed: Mar. 8, 2000

### FIELD OF THE INVENTION

The invention generally relates to a method, via an intermediary, to develop new prospects and clients, and to maintain and manage clients and their business derived from the Global Equestrian Community by global financial institutions offering private banking, wealth management services and other financial advisory services for the ultra net worth and high net worth individuals and families designated as four different participating categories in the described Equestrian Wealth Management Program. For a financial institution offering qualified global private banking, wealth management services and other financial advisory services, the method identifies and accesses in a meaningful, efficient, effective manner qualified prospects and clients derived from the Global Equestrian Community via an intermediary that is established in the Global Equestrian Community and polo team sponsorship and/or equestrian participant sponsorship organized by the intermediary. As such, the financial institution is provided an equestrian peer participant status and an insider status in the Global Equestrian Community rather than a perceived commercial status and has an enhanced competitive status and material advantage to develop and to manage prospects, clients, and clients' business.

### BACKGROUND OF THE INVENTION

For global financial institutions providing qualified private banking, wealth management services and other financial advisory services to ultra wealthy and high net worth individuals, families and related businesses, the two most inefficient and expensive business development activities are 1) identifying qualified prospects and clients, and 2) accessing the identified qualified prospects and clients in an meaningful, efficient and effective manner with a high probability of success that the prospect becomes a meaningful client in a timely manner. Today, global financial institutions providing private banking-wealth management services have scores of private bankers traveling the world seeking to identify new prospects, and clients in an organized but somewhat random process that uses the law of averages to succeed. It is extremely inefficient, unproductive and expensive.

The described Equestrian Wealth Management Program provides a deliberate, systematic, Business Method that either eliminates or minimizes to the fullest extent possible these two businesses and financial inefficiencies/ineffectiveness incurred by the global financial institution and provides the financial institution a distinct competitive advantage by the status created. The Equestrian Wealth Management Program provides a method, via a participating intermediary established in the Global Equestrian Community, to identify and to access in a meaningful, efficient and effective manner qualified private banking-wealth management prospects and clients in the Global Equestrian Community for the financial institution. The intermediary is essentially a front end or virtual equestrian bank for the financial institution.

The Global Equestrian Community is composed of three primary equestrian disciplines: Polo, Dressage and Jumping. Accessing individual participants in the Global Equestrian Community in a meaningful efficient and effective manner is difficult. At the highest level, the individual participants (composed in four primary categories) annually spend hundreds of thousands of dollars and in some cases millions of dollars in operating expenses to participate in equestrian activities on a global or seasonal basis and spend millions of dollars on supporting capital expenditures on horses, real estate, stables and similar items—often times in multiple locations for local seasonal activities. At the global level, each of the defined Global Equestrian Communities participant categories are (by definition) qualified candidates for high level private banking-wealth management services and other financial advisory services. As a result, the large amounts of money spent by financial institutions to identify and to access qualified prospects and clients is eliminated or minimized and is channeled in an organized, focused, disciplined program.

The invented Business Method 1) identifies the qualified participants in the defined Global Equestrian Community participating at various global equestrian venues and that reside in different global locations, and 2) provides an effective means for financial institutions to access the qualified Global Equestrian Community participant in a non-commercial manner, via an established participating intermediary, by creating a special status as a participating equestrian peer and insider. The intermediary has a non-commercial, historical presence in the Global Equestrian Community and in the private banking sector and is, effectively, the bridge, for the financial institutions that desire to cultivate and to attract the Global Equestrian Community participants as prospects and as clients and to manage and maintain their business in a unique tripartite manner. The intermediary does so by participating in the equestrian activity as a playing polo team member, organizing the polo team sponsorship by the financial institution, and by creating a strategic presence of the financial institution in the global Polo Community and/or with sponsorship of a qualified equestrian participant which is transferable to the participants in the global Dressage Community and the Jumping Community.

With the qualified intermediary as the bridge and equestrian market access point, the financial institution is transformed from a commercial outsider to an insider and essentially becoming a peer participant on the same participatory level as the client prospect and in essence sits on the same sport bench as the equestrian participant who is the targeted private banking-wealth management prospect/client. In this manner, the financial institution is not viewed as a commercial participant but as a peer participant. The normal, traditional barriers to access (identify the qualified prospect, unable to make appointment with the prospect, unable to access the prospect, cold office environment, plethora of advisors to navigate, etc.) to the prospect/client do not exist or are completely minimized.

With this enhanced competitive status, the global financial services provider is able to attract the prospect as a client and/or to increase the relationship and to inter-relate and to provide services to the client, derived from the Global Equestrian Community via the Business Method, by three distinct integrated categories of service providing: 1) location of equestrian events at equestrian venues 2) location of client from the Global Equestrian Community which is typically different from equestrian venue; and 3) location of the assets, desired location of the global assets as requested by the client derived from the Equestrian Community. The intermediary is essentially a front end or virtual equestrian bank for the financial institution.

### BRIEF SUMMARY OF THE INVENTION

Accordingly, the first objective of the invention is to provide an efficient, competitively enhanced and cost effective method to develop, to maintain, and to manage, via the intermediary established in the global Equestrian Community and the strategic global polo team sponsorships and/or high level equestrian participant sponsorship, new client prospects and clients derived from the Global Equestrian Community (primarily Polo, Dressage, and Jumping) for financial institutions.

The second objective of the invention is to create a participating equestrian peer status for the financial institution, via the intermediary, as a bridge and equestrian market access point to the Global Equestrian Community and organizer of the global sponsored polo teams and/or sponsorship of high level equestrian participants.

A third objective of the invention is to create, via the intermediary, a peer participant status in the Global Equestrian Community for the financial institution offering the private banking wealth management services so that the traditional barriers to prospect/client identification and access and are either eliminated or reduced to the minimum. This status elevates the financial institution status in the global Equestrian Community and acts as a competitive barrier to entry to other competitors attempting to access members the Global Equestrian Community.

A fourth objective of the invention is, through implementation of the Equestrian Wealth Management Program, to cause a material reduction in the cost and a material enhancement in the efficiency of new prospect-client development with the assistance of the intermediary.

A fifth objective of the invention is to provide, via the intermediary, the financial institution with an insider status from the perception of existing financial institution clients and the social participant in the Global Equestrian Community and provide a unique enhanced existing client entertainment destination for “behind the scenes” participation as an insider in rarified elite, extreme equestrian sports.

A sixth objective of the invention is to more efficiently utilize the time of the financial services provider through its private bankers, via the intermediary, (access provider to and organizer of the Global Equestrian Community), who directs the private bankers to attend events, meet prospects, organize events for the private bankers to attend, and otherwise access members of the Global Equestrian Community in a structured, efficient manner via the global polo team sponsorships and/or the high level equestrian participant sponsorship rather than a random, commercial approach. The intermediary is essentially a front end or virtual equestrian bank for the financial institution.

### BRIEF DESCRIPTION OF THE DRAWINGS

FIG. 1 Is an information flow schematic diagram of the intermediary's presence, access, and integration in the Global Equestrian Community (Polo, Dressage, and Jumping) predicated on the combination of Palm Beach equestrian activities integrated with global equestrian events, venues and participants.

FIG. 2 Is a diagram illustrating the financial qualifications (Private Banking-Wealth Management) of the Global Equestrian Community participants.

FIG. 3 Is a schematic diagram of the peer participant status and the insider status in the Global Equestrian Community of the global Financial institution via Intermediary as the front end or virtual equestrian bank pursuant to the strategic alliance with the financial institution which are predicated on polo team sponsorship or high level equestrian participant sponsorship and/or the integrated presence of intermediary in the Global Equestrian Community for the purpose identification, accessing and developing prospects and clients derived from the Global Equestrian Community and client entertainment of the social-access participant.

FIG. 4 Is a schematic diagram of the Global Equestrian Community participants in four basic categories subject to further refinement and the leveragability of each category for the development and growth of the Equestrian Wealth Management Program.

FIG. 5 Is a diagram illustrating the Global Equestrian Community participants' expenditures at Equestrian Venues which illustrate the qualifications of the participants for private banking-wealth management services.

FIG. 6 Is a schematic diagram of the Polo Team and the High Level Equestrian Participant Sponsorships, peer participant status and insider status created by Intermediary as the front end or virtual equestrian bank, the integral value of the polo team sponsorship or high level equestrian participant sponsorship, and transferable values to Polo, Dressage and Jumping participants with management of the prospect and client and their business derived from the Equestrian Wealth Management Program.

FIG. 7 Is a process flow diagram explaining the intermediary creation and management of the Equestrian Wealth Management Program and its integration with the Global Offices and the Client Representative Officers/Private Bankers of the financial institution, participation model in the identification, development of prospects and clients and the management of the prospects and clients their private banking and wealth management business and relationships.

FIG. 8 Is a schematic diagram of the generation of prospects and clients derived from the Equestrian Wealth Management Program, the polo team sponsorship and the equestrian participant sponsorship and the development, maintenance and management for private banking-wealth management services and relationships with the prospects and clients.

FIG. 9 Is a schematic diagram of the servicing of clients derived from the Equestrian Wealth Management Program on a multi-prong basis consistent with the characteristics of Global Equestrian Community participants..

FIG. 10 Is a logic flow schematic diagram explaining how the four categories of participants in the Global Equestrian Community are sourced for the Equestrian Wealth Management Program by intermediary as the front end or virtual equestrian bank for the financial institution which are identified, accessed, developed, maintained and managed by intermediary and then with the integration of the financial services provider.

FIG. 11 Is an integrated process flow schematic diagram of the polo team sponsorship and/or high level equestrian participant sponsorship, the four categories of the equestrian participants from which prospects and clients are derived for the Equestrian Wealth Management Program and the decision making involving intermediary, the Financial institution and the Global Equestrian Community participant.

### DETAILED DESCRIPTION OF THE INVENTION

The invention relates to a method created to provide business development activities, client development, client maintenance and client management activities derived from and related to the Global Equestrian Community (disciplines of Polo, Dressage, Jumping) called global Equestrian Wealth Management Program (“Equestrian Wealth Management Program”). It is focused on the identification and accessing qualified prospects and clients in the global equestrian disciplines of Polo, Dressage and Jumping (Global Equestrian Community) to provide private banking-wealth management services to manage, maintain, develop and deploy the financial assets of global participants in a unique tripartite manner. The access to this Global Equestrian Community participants is premised on the creation, via an intermediary, of a peer participant status and insider status of the financial institution which permits identification and meaningful access to the Global Equestrian Community participants as a participating peer and, from the perspective of the financial institutions' existing clients and social participants a perception, created by the intermediary via polo team sponsorships and/or high level equestrian participant sponsorships, that the financial institution is a global Equestrian Community insider,

The Equestrian Wealth Management Program provides a deliberate, systematic Business Method that either eliminates or minimizes to the fullest extent possible the two most inefficient/ineffective and expensive business development activities incurred by the global financial institution: 1) identifying qualified prospects and clients and 2) accessing the identified qualified prospects and clients in an meaningful, efficient and effective manner with a high probability of success. The Equestrian Wealth Management Program provides, via the intermediary and the polo team sponsorship and/or the high level equestrian participant sponsorship, the participating financial institution a participating peer status and an insider status. This status is a competitive barrier to entry for the financial institution and provides a unique position to also manage the assets of the prospects and clients in a tripartite manner based on equestrian venue locations, prospect/client location, and asset location.

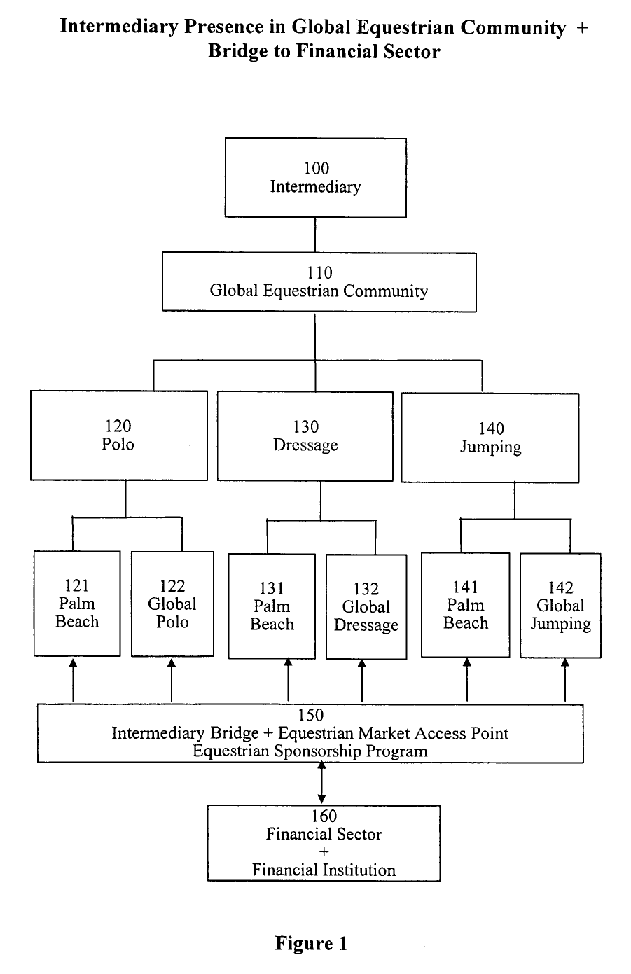

FIG. 1 Is an information flow schematic diagram of the intermediaries established participating presence in the Global Equestrian Community (Polo, Dressage, and Jumping) and its global venues.

As illustrated, the intermediary, 100, is an existing, historical participant in the Global Equestrian Community, 110, with a non-commercial pre-existing status and existing credibility and access in the global Equestrian Community 110.

The Global Equestrian Community, 110, is composed of three primary equestrian disciplines: Polo 120, Dressage, 130, and Jumping, 140.

The one primary venue for the three equestrian disciplines is Palm Beach 121, 131, 141, with the Winter Equestrian Season (December-April) and the Equestrian Preserve Area of some 7,500 acres devoted to the highest level of equestrian disciplines. The Equestrian Wealth Management Program and the intermediary are anchored in Palm Beach and internationally extended to other events and venues for Global Polo, 122, Global Dressage, 132, and Global Jumping, 142.

With the established intermediary and the intermediary's equestrian sponsorship program as the bridge-equestrian market access point, 150, the involved financial institutions 160, essentially become a participant on the same level as the prospect-client and in essence sits on the same sport bench as the equestrian participant who is the targeted private banking-wealth management prospect-client. In this manner, the private banking service provider is not viewed as a commercial participant but as a peer participant status and gains an insider status to outsiders and social participants. The normal barriers to access (able to make appointment, unable to access the person, cold office environment, plethora of advisors to navigate, etc.) to the Global Equestrian Community prospect-client do not exist or are minimized 160.

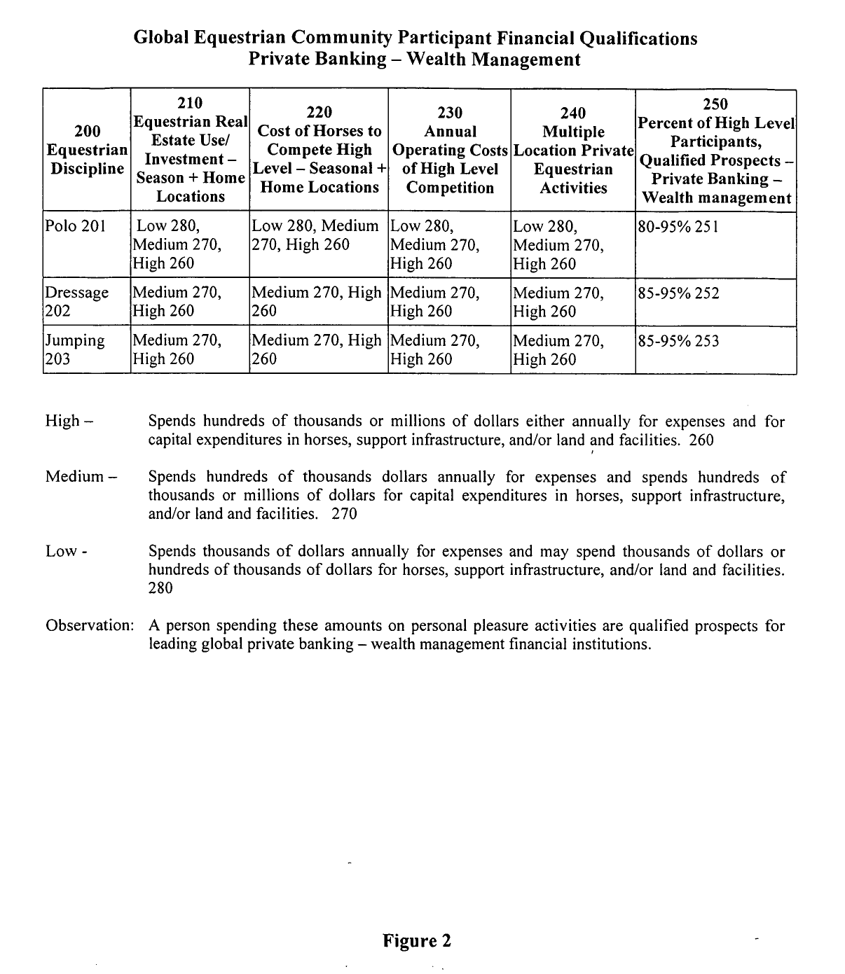

FIG. 2 Is a diagram illustrating the financial qualifications 210, 220, 230, 240, 250 (Private Banking-Wealth Management) of the Global Equestrian Community participants 200. Each of the Global Equestrian Community participants, 200, are in one or more equestrian disciplines (Polo, 201, Dressage, 202, Jumping, 203) and are financially qualified for high level Private Banking-wealth management services due to the amount of money spent on the equestrian sport at this level in these venues and in these communities, 210, 220, 230, 240, 250. Whether the Global Equestrian Participant is in the low 280 (spends thousands of dollars annually for expenses and may spend thousands of dollars or hundreds of thousands of dollars for horses, support infrastructure, and/or land and facilities), medium, 270 (spends hundreds of thousands dollars annually for expenses or and may spend hundreds of thousands or millions of dollars for capital expenditures in horses, support infrastructure, and/or land and facilities or high 260 (spends hundreds of thousands or millions of dollars either annually for expenses or for capital expenditures in horses, support infrastructure, and/or land and facilities) expenditure level for Equestrian Real Estate use and investment Season—Venue locations and in home locations, 210, cost of horses to compete at a High Level every Season—Venue locations and in Home locations, 220, annual operating costs of High Level Competition, 230, various venues and locations, annual costs of Multiple Location Private Equestrian Activities, 240, the person is a qualified prospect—client for the financial institution providing Private Banking-Wealth Management services and other financial advisory services. 250.

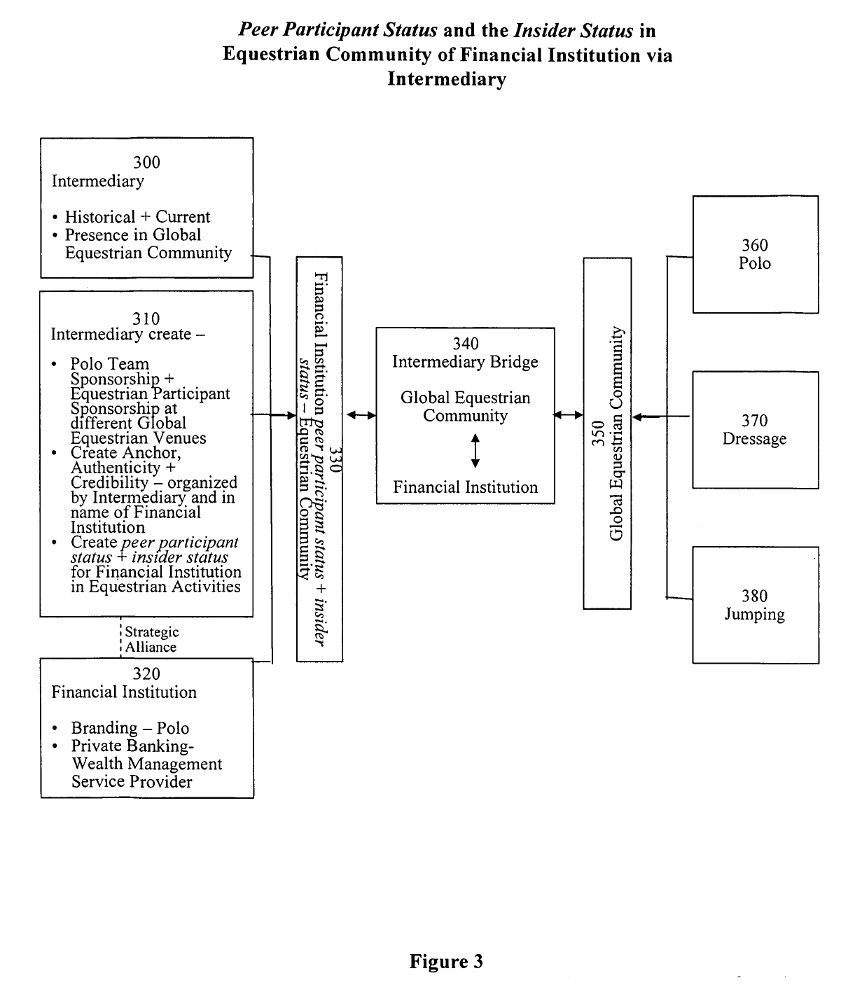

FIG. 3 Is a schematic diagram of the peer participant status and the insider status in the Global Equestrian Community created for the global financial institution pursuant to the strategic alliance with the financial institution which are predicated on polo team sponsorship or equestrian participant sponsorship and/or the integrated presence of intermediary in the Global Equestrian Community for the purpose identification, accessing and developing prospects and clients derived from the Global Equestrian Community.

The intermediary, 300, has a non-commercial, existing, historical presence in the Global Equestrian Community and is, effectively, the bridge-equestrian market access point, for the financial institutions that desire to cultivate and to attract the Global Equestrian Community participants as clients and to involve social participants and existing clients in the Global Equestrian Community. The intermediary does so by participating in the equestrian event, in the name of the financial institutions as a playing polo team member/polo team and/or as a high level equestrian participant sponsor. 310, 320, 330, 340.

As a professional polo team sponsor and/or high level equestrian participant sponsor, the polo team and/or the high level equestrian participant bears the name of the financial institution (i.e., “XX Bank Polo Team” or “XX high level Equestrian Participant”) organized by the intermediary, the targeted Global Equestrian Community participant (prospect-client) perceives the financial institution as equestrian participant or insider and does not perceive the financial institution as a commercial intruder, 310, 330.

The Polo Team Sponsorship or high level equestrian participant is an anchor that creates authenticity, credibility and a Peer Participant Status and Insider Status and that provides an effective means to access the qualified Equestrian Community participant in a non-commercial manner, 310,330,340, 350, 360, 370, 380.

The intermediary identifies the qualified participants in the Global Equestrian Community participating at various global equestrian venues and that reside in different global locations, and provides an effective means or bridge to access the qualified Equestrian Community participant in a non-commercial manner, as a participating equestrian peer or insider, 310, 330, 340, 350. Via the intermediary and the polo team participation and/or high level equestrian participant sponsorship, the financial institution is enabled to establish a friend, trust, relationship derived from peer participant status and insider status which is effective inside and outside the Global Equestrian Community. The relationship is materially enhanced and is non-commercial. It is then possible to evolve the relationship from prospect-client to friend to trust to private banking-wealth management relationship, 320, 330, 340, 350, 360, 370, 380.

With the intermediary as the bridge-equestrian market access point 340, the financial institution essentially becomes a peer participant and insider on the same level as the prospect-client and in essence sits on the same sport bench as the Global Equestrian Community participant who is the targeted private banking-wealth management prospect-client. 340, 350, 360, 370, 380

At the global level, each of the Global Equestrian Communities participant categories 350, Polo, 360, Dressage, 370, and Jumping, 380, are (by definition) qualified candidates for high level private banking-wealth management services. As a result, the large amounts of money spent by Financial Institutions in the necessity of identifying categories of qualified candidates, prospects and clients is eliminated or minimized and is effectively channeled. Otherwise accessing individual participants in the Global Equestrian Community in a meaningful manner is difficult.

In this manner, the private banking service provider is not viewed as a commercial participant but as a peer participant or insider. The normal, traditional barriers to access (identify the qualified prospect, unable to make appointment with the prospect, unable to access the prospect, cold office environment, plethora of advisors to navigate, etc.) to the prospect—client do not exist or are completely minimized.

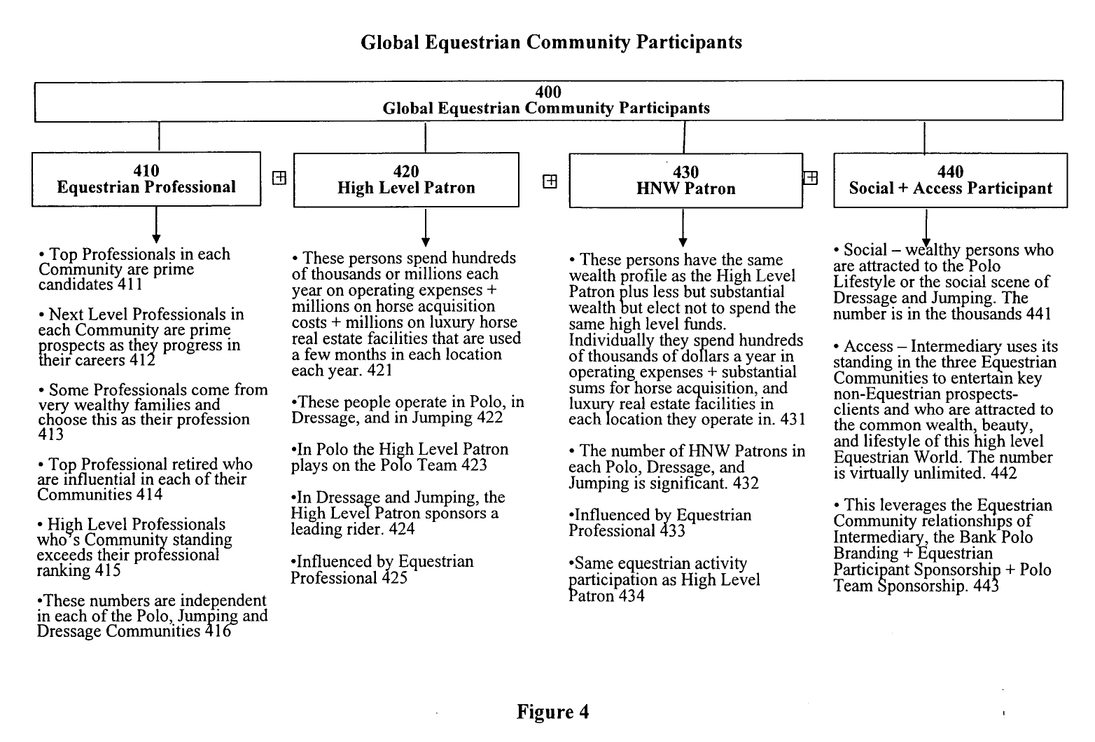

FIG. 4 Is a schematic diagram of the Global Equestrian Community participants by category 410, 420,430,440.

The Global Equestrian Community is derived from the distinct equestrian disciplines of Polo, Dressage and Jumping. Within each equestrian discipline, there are four primary groups of prospects—clients 400: 1) Equestrian Professionals 410; 2) High Level Patrons 420; 3) High Net Worth (“HNW”) Patrons 430; and 4) Social-Access Participants 440. Each of the Global Equestrian Community Participants 410, 420, 430, 440 that becomes a client or is supportive of the participating financial institution (via polo team sponsorship or high level equestrian participant sponsorships in global polo/equestrian venues and events) effectively becomes an ambassador, credibility provider, and access provider for the financial institution to other Global Equestrian Community participants who are similarly client prospects. Providing a snapshot of the Equestrian Professional 410, in each Equestrian Community, top Professionals are prime prospects-clients and the next levels of Professionals in each country are prime prospects-clients as they progress in their carriers, 412. Some professional come from very wealthy families and choose this as their profession, 413. Top Professional retired are influential in each of their Communities, 414. High Level Professional's standing exceeds their professional ranking, 415. All these numbers are independent in each of the Polo, Jumping and Dressage Communities.

An Equestrian Professional, 410, is typically sponsored by or is hired by High Level Patrons, 420 or HNW Patrons, 430.

High Level Patrons 420, spend millions or hundreds of thousands of dollars each year on equestrian sport operating expenses, millions or hundreds of thousands of dollars on horse acquisition costs and millions on luxury horse real estate facilities that are used a few months in each equestrian venue/location each year, 421. These people operate in Polo, Dressage and in Jumping, 422. In Polo, the High Level Patron plays on the Polo team, 423. In Dressage and Jumping, the High Level Patron sponsors a leading rider, 424.

The High Level Equestrian Professional 410, has a very close intimate relationship with the Patron/Sponsor 425. An introduction by the High Level Equestrian Professional/Participant to the Patron/Sponsor eliminates years of time and eliminates barriers while providing the highest probability of success. The same is true when a High Level Patron becomes a client and then introduces a financial institution to other Patrons/Sponsors.

HNW Patrons, 430, have the same or similar wealth profiles as the High Level Patron with similar or less but substantial wealth but elect not to spend the same high level funds on the equestrian sport. Individually, they may spend hundreds of thousands of dollars a year in operating expenses and substantial sums for horse acquisition, and luxury real estate facilities in each equestrian venue location they operate in, 431. The number of HNW Patrons in each Polo, Dressage and Jumping discipline is significant, 432. They are also influenced by the Equestrian Professionals, 433, and have the same activity participation as the High Level Patrons, 434. With respect to the Social-Access Participant, 440, they are social-wealthy persons who are attracted to the Polo, Dressage, and/or Jumping Equestrian Lifestyle or the social scene of Polo. Dressage and/or Jumping. The number is in the thousands up to hundreds of thousands, 441. To access, the intermediary uses its standing in the three disciplines of the Global Equestrian Communities to entertain key non-Equestrian prospects or existing clients of the financial institution and who are attracted to the common wealth, beauty and lifestyle of this high level Equestrian World. The number is virtually unlimited, 442. This leverages the Equestrian Community relationships of the intermediary and the peer participant status and insider status, created for the financial institution by the Polo Branding and the Polo Team Sponsorship and/or the high level equestrian participant sponsorship, 400, 443.

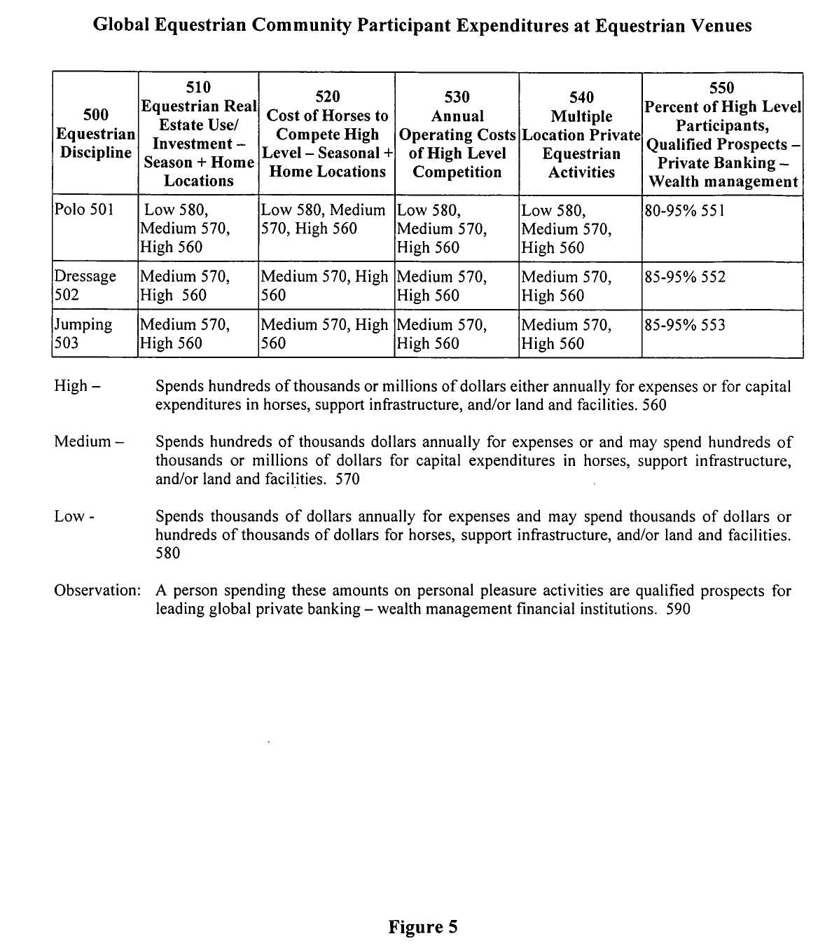

FIG. 5 Is a diagram describing the Global Equestrian Community participants' (Polo, 501, Dressage, 502, Jumping, 503) expenditures by category (high 560, medium 570, low 580) in the equestrian sport activities and at Equestrian Venues/locations and home.

Whether the Global Equestrian Participant is in the low 580 (spends thousands of dollars annually for expenses and may spend thousands of dollars or hundreds of thousands of dollars for horses, support infrastructure, and/or land and facilities), medium, 570 (spends hundreds of thousands dollars annually for expenses or and may spend hundreds of thousands or millions of dollars for capital expenditures in horses, support infrastructure, and/or land and facilities or high 560 (spends hundreds of thousands or millions of dollars either annually for expenses or for capital expenditures in horses, support infrastructure, and/or land and facilities) expenditure level for Equestrian Real Estate use and investment Season—Venue locations and in home locations, 510, cost of horses to compete at a High Level every Season—Venue locations and in Home locations, 520, annual operating costs of High Level Competition, 530, various venues and locations, annual costs of Multiple Location Private Equestrian Activities, 540, the person is a qualified prospect and client for the financial institution providing Private Banking-Wealth Management services 550.

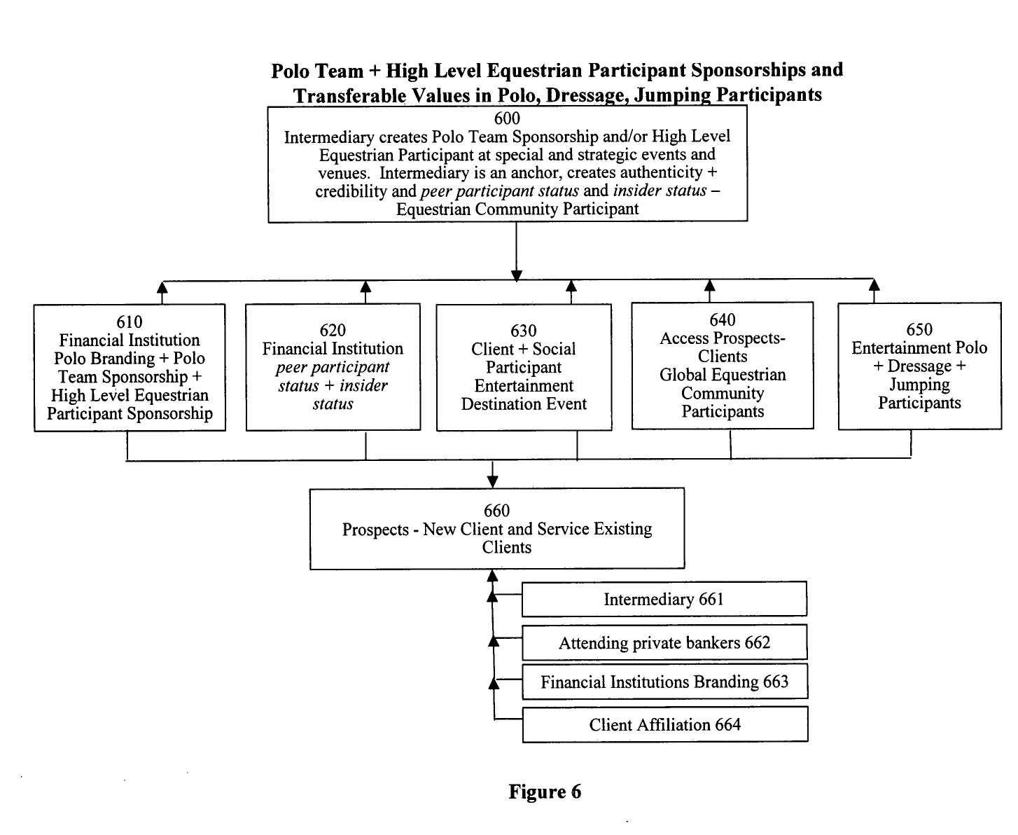

FIG. 6 Is a schematic diagram of the Polo Team Sponsorships, peer participant status and insider status created by Intermediary as the front end or virtual equestrian bank, the integral value of the polo team sponsorship or equestrian participant sponsorship, and transferable values to Polo, Dressage and Jumping participants with management of the prospect and client derived from the Equestrian Wealth Management Program.

The Polo Team Sponsorship and/or high level equestrian participant sponsorship 600, 610 are an anchor created by the intermediary that creates authenticity, credibility an a Peer Participant Status and Insider Status for the financial institution 620 and that provides an effective means to access the qualified Equestrian Community participant 630, 640, 650 in a non-commercial manner and to access social participants and existing clients, 600, 660.

Via the intermediary and the participation program created, the financial Institution sponsors a polo team and/or high level equestrian participant at special events, special venues and in strategic equestrian events 610. Similarly, the financial institution sponsors a leading high level equestrian participant in the Dressage/Jumping disciplines. With this peer participatory status and insider status, the financial institution is no longer a commercial participant but has a peer participant status and insider status, 620. Sponsorship of a participating polo team and/or the high level equestrian participant is transferable to the other equestrian disciplines of dressage and jumping and to non-equestrian activities. The financial institution gains a sitting on the same sport bench status as the prospect-client targeted for private banking-wealth management services and the financial institution can use this privileged status position for entertainment and destination event for its own Clients, 630.

At the highest level, all participants in the Global Equestrian Community (Polo, Dressage, Jumping) are qualified prospects—clients for global private banking-wealth management services and provide enhanced existing client entertainment destination for behind the scenes participation in a rarified elite, extreme sport, 640, 650.

With this privileged peer participant and insider status position, this situation can also be applied as a way of entertainment for the Polo, Dressage and Jumping participants, 650.

The environment created provides a platform to access prospects-clients, provide services to existing clients, 660, and facilitates the activities of the intermediary, 661, the attending private bankers 662, the financial institutions Branding, 663 and Client Affiliation, 664.

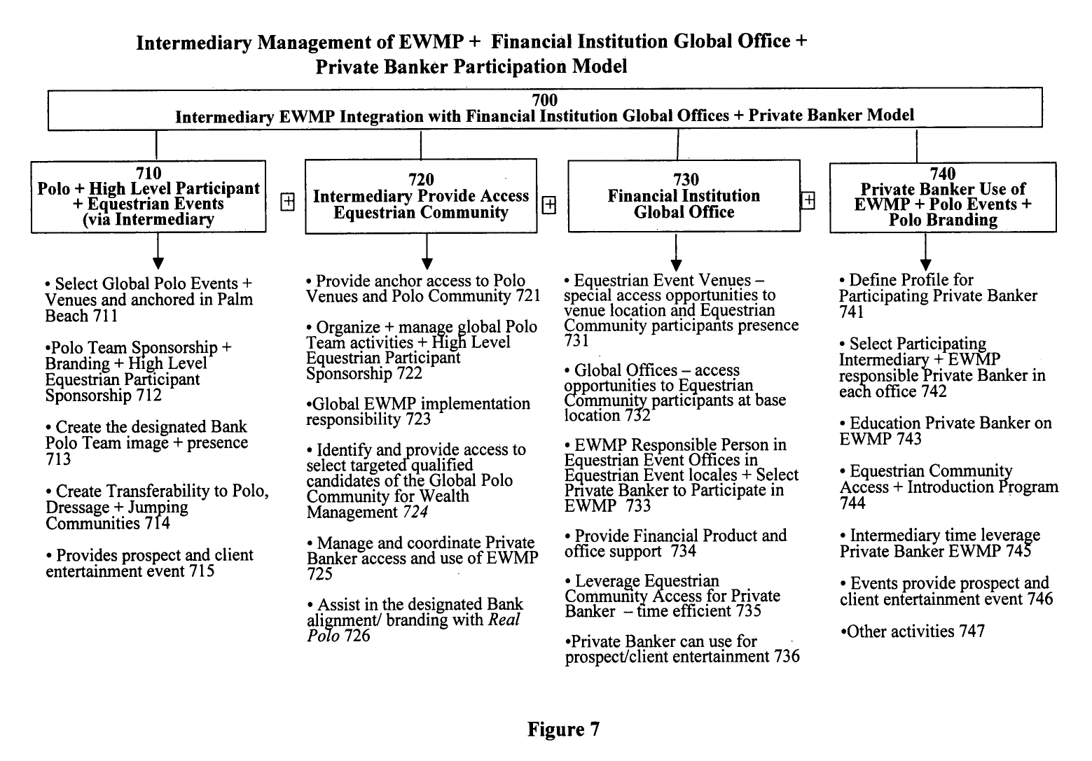

FIG. 7. Is a process flow diagram explaining the intermediary creation and management of the Equestrian Wealth Management Program and its integration with the Global Offices and the Client Representative Officers/Private Bankers of the financial institution 700, participation model in the identification, development of prospects and clients and the management of the prospects and clients their private banking-wealth management business and relationships 710, 720, 730 and 740.

To effectively and efficiently implement the Equestrian Wealth Management Program there must be a significant integration between the intermediary, the financial institution Global Offices and the private banker participation model, 700.

For Polo and other Equestrian Events, 710, this integration is necessary in order to select Global Polo Events, high level equestrian sponsorship activities, and venues and anchor them in Palm Beach, 711, decide the Polo Team Sponsorship/High Level Equestrian Sponsorship and Branding, 712, create the designated Polo Team/High Level Equestrian Sponsorship image and presence, 713, create transferability to the Dressage and Jumping equestrian communities, 714 and for providing prospect and client entertainment events, 715.

The intermediary provides to the financial institution anchor access to the Global Equestrian Community, 720, to Polo venues and Polo Community, 721, organizes and manages Global Polo Team activities, 722, has the responsibility of the implementation of the Global Equestrian Wealth Management Program, 723, identifies and provides access to select targeted qualified candidates of the Global Polo Community for Wealth Management, 724, manages and coordinates private banker's access and use of the Equestrian Wealth Management Program, 725 and assists in the designated Bank alignment and branding with Real Polo, 726.

Furthermore, the financial institution Global Office, 730, through its Offices in locales of Equestrian Event, has special access opportunities to venue location and Equestrian Community participant presence, 731. The Global Office has also access opportunities to the Equestrian Community participant at its base location, 732. There must be an Equestrian Wealth Management Program responsible person in each Equestrian Event Offices and selected private banker's to participate in the Equestrian Wealth Management Program, 733.

The Global Office will also provide financial product and office support, 734, and must leverage the Equestrian Community Access for its private banker's in a time efficient manner, 735. Private bankers can be used for prospect and client entertainment, 736.

The integration of the intermediary's Equestrian Wealth Management Program it is also necessary with the private banker's use of the Equestrian Wealth Management Program in Polo Events and Polo Branding, 740. A selection profile for the participating private bankers in the Equestrian Wealth Management Program is defined, 741, select the participating private banker's and the Equestrian Wealth Management Program responsible private banker in each financial institution Global Office, 742, educate private banker's on the Equestrian Wealth Management Program, 743, create an Equestrian Community access and introduction program, 744, determine the private banker's time leverage of the intermediary's Equestrian Wealth Management Program, 745. The events and other activities coming from the Equestrian Wealth Management Program will provide private banker's prospect and client entertainment event, 746, 747.

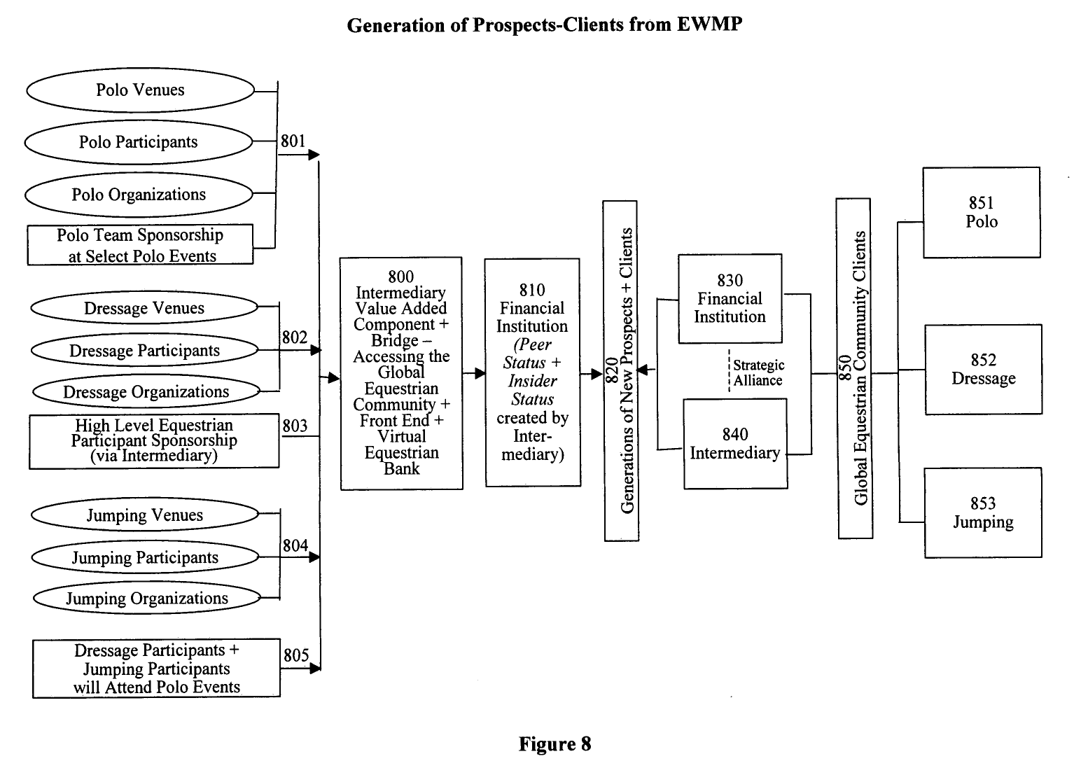

FIG. 8 Is a schematic diagram of the Generation of Clients derived from the Equestrian Wealth Management Program, the polo team sponsorship and the high level equestrian participant sponsorship and the development, maintenance and management for private banking-wealth management services and relationships with the prospects and clients

Derived from different Polo Venues, Polo Participants, Polo Organizations and Polo Team Sponsorships at Select Polo Events, 810, as well as Dressage Venues, Participants and Organizations, 820, High Level Equestrian Participant Sponsorships 803, and, finally, Jumping Venues, Participants, and Organizations, the Business Method 1) identifies the qualified participants in the defined Global Equestrian Community participating at various global equestrian venues 801, 802, 803, 804, 805 and that reside in different global locations, and 2) provides an effective means to access the qualified Equestrian Community participant in a non-commercial manner, via the peer participant status and the insider status created by the intermediary, 800, as a participating equestrian peer and insider 810. The intermediary has a non-commercial, historical presence in the Global Equestrian Community and is, effectively, the bridge and equestrian market access point, creating an anchor and credibility for the financial institution that target and cultivates and attracts the Global Equestrian Community participants as prospects-clients 800.

With the intermediary as the bridge-equestrian market access point, 800, the financial institution essentially becomes a participant on the same level as the prospect-client and in essence sits on the same sport bench as the equestrian participant who is the targeted private banking-wealth management prospect-client. In this manner, the private banking service provider is not viewed as a commercial participant but as a peer participant or insider, 810. The normal, traditional barriers to access (identify the qualified prospect, unable to make appointment with the prospect, unable to access the prospect, cold office environment, plethora of advisors to navigate, etc.) to the client prospect do not exist or are minimized.

To utilize the Equestrian Wealth Management Program, and for the generation of new prospects-clients, 820, the intermediary creates and implements the Equestrian Wealth Management Program, 840, and the financial institution, 830, the intermediary creates a Strategic Alliance with the intermediary as the front end for the financial institution in accruing and developing the wealth management opportunities in the Global Equestrian Community with the intermediary essentially becoming a virtual equestrian bank, 850.

Via the intermediary, the financial institution sponsors a polo team and/or high level equestrian participant at special venues and in strategic equestrian events. With this peer participatory status and insider status created by the intermediary's implementation of the Equestrian Wealth Management Program, the financial institution is no longer a commercial participant but has achieved a peer participant status and insider status and has direct access to the Global Equestrian Community Clients, 850. Sponsorship of a participating polo team and/or the high level equestrian participant is transferable to the other equestrian disciplines of Dressage and Jumping. 851, 852, 853.

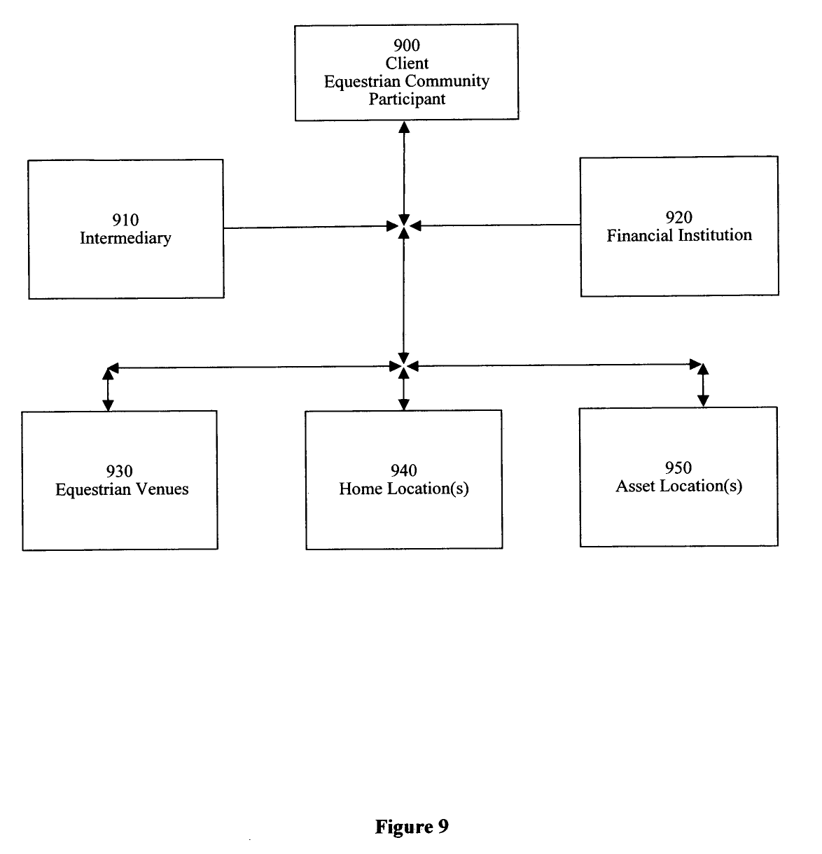

FIG. 9 Is a schematic diagram of the servicing of clients derived from the Equestrian Wealth Management Program on a multi-prong basis consistent with the characteristics of Global Equestrian Community participants.

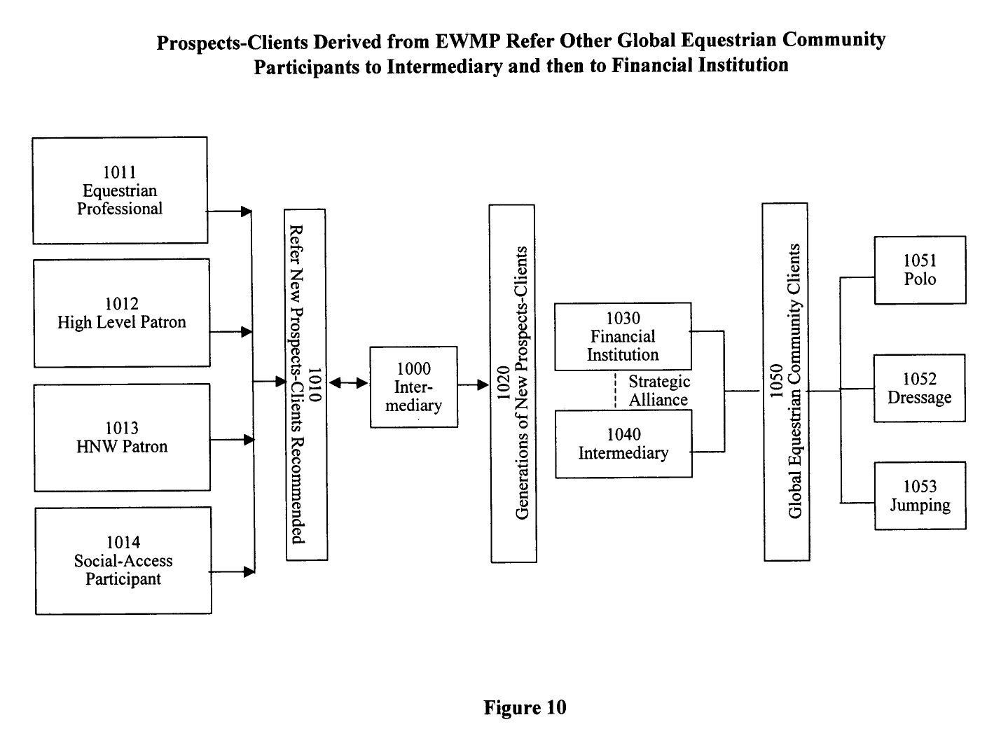

The financial institution, 920, is able to provide services to the client, derived from the Global Equestrian Community, 900, via the intermediary and the Equestrian Wealth Management Program, 910, by three distinct integrated categories of service providing: 1) location of equestrian events at seasonal equestrian venues, 930, 2) location of client from the Global Equestrian Community which is typically different from equestrian venue, 940, and 3) location of the assets, desired location of the global assets as requested by the client derived from the Equestrian Community, 950. This tripartite approach facilities the client relationship and makes the financial institution-client relationship client centric premised on their equestrian activities. FIG. 10 Is a logic flow schematic diagram explaining how the four categories of participants in the Global Equestrian Community are sourced for the Equestrian Wealth Management Program by intermediary as the front end or virtual equestrian bank for the financial institution which are identified, accessed, developed, maintained and managed by intermediary and then with the integration of the financial services provider.

The Global Equestrian Community participants are divided into four participating categories: 1) Equestrian Professionals, 1011; 2) High Level Patrons, 1012; 3) HNW Patrons, 1013; and 4) Social-Access Participants, 1014.

Each of the Global Equestrian Community Participants, 1011, 1012, 1013, 1014, that become a client or supportive of the financial institution (via polo team sponsorship and/or high level equestrian sponsorship in global polo/equestrian venues and events) effectively becomes an ambassador, credibility provider, and access provider for the financial institution with other Global Equestrian Community participants who are similarly prospects-clients, 1020.

As an example, a High Level Equestrian Professional, 1011 is typically sponsored by or is hired by High Level Patrons, 1012 or HNW Patrons, 1013. The High Level Equestrian Professional has a very close intimate relationship with the Patron/Sponsor. An introduction by the High Level Equestrian Participant to the Patron/Sponsor eliminates years of time and eliminates barriers while providing the highest probability of success. The same is true when a High Level Patron becomes a client and then introduces a financial institution to other Patrons/Sponsors, 1020. With respect to the Social-Access Participant and as a result of the intermediary's implementation of the Equestrian Wealth Management Program, 1014, financial institution is perceived as a peer participant and insider in the Global Equestrian Community which provides credibility, status and trust to the Social-Access participant. Therefore, there is a higher probability of success in turning that social-access participant into a Client. The Social-Access Participant may or may not have any knowledge of the Global Equestrian Community but desires to have the aspiration or affiliation status by attending and participating in Global Equestrian Community events. These high level Global Equestrian Community events have the image and aura of wealth, power, social status, celebrity, sex, sports, and unique participatory status by the financial institution.

With intermediary as the bridge-equestrian market access point and the intermediary's implementation of the Equestrian Wealth Management Program, 1000, the financial institution essentially becomes a participant on the same level as the client prospect and in essence sits on the same sport bench as the equestrian participant who is the targeted private banking-wealth management candidate/prospect/client. The normal barriers to access to the prospect-client do not exist or are minimized.

For the generation of new prospects-clients, 1020, it is necessary to create a strategic alliance between the intermediary, 1040, and the financial institution, 1030, a Strategic Alliance for intermediary to be a front end or Virtual equestrian bank for the financial institution in accruing and developing the wealth management opportunities in the Global Equestrian Community, 1050. Via the intermediary and the Equestrian Wealth Management Program implementation, the financial institution sponsors a polo team and/or high level equestrian participant at special venues and in strategic equestrian events. With this peer participatory status and insider status, the financial institution is no longer a commercial participant but has a peer participant status and insider status and has direct access to the Global Equestrian Community Clients, 1050. Sponsorship of a participating polo team is transferable to the other equestrian disciplines of Dressage and Jumping. 1051, 1052, 1053.

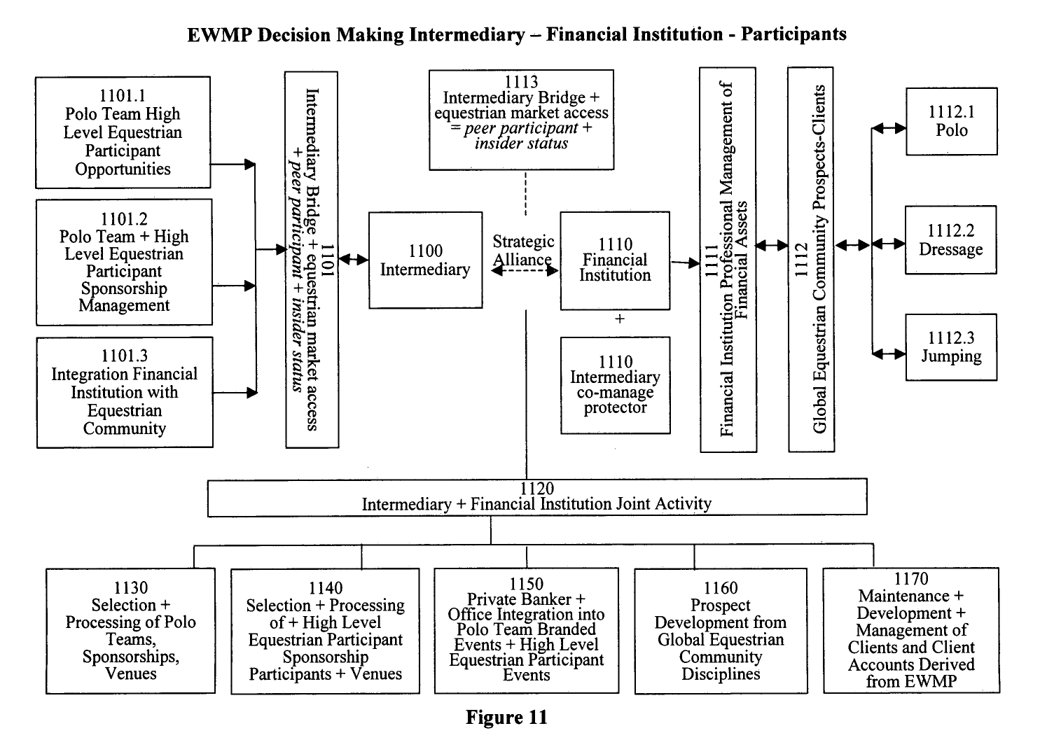

FIG. 11 Is an integrated process flow diagram of the polo team sponsorship and/or high level equestrian participant sponsorship, the four categories of the equestrian participants from which prospects and clients are derived for the Equestrian Wealth Management Program and the decision making involving intermediary, the Financial institution and the Global Equestrian Community participant.

Intermediary, 1100 and the financial institution, 1110 have created a Strategic Alliance for the additional execution of the Equestrian Wealth Management Program concept. In essence, intermediary, 1100, will be a bridge, front end and Virtual equestrian bank for the financial institution in the Global Equestrian Community.

With intermediary as the bridge-equestrian market access point 1101, 1113, the Financial institution essentially becomes a peer participant on the same level as the prospect-client. In this manner, the private banking service provider is not viewed as a commercial participant but as a peer participant or insider. The normal barriers to access (able to make appointment, unable to access the person, cold office environment, plethora of advisors to navigate, etc.) to the client prospect do not exist or are minimized.

Intermediary will create, organize and manage Polo Team and High Level Equestrian Sponsorship Opportunities for the financial institution. The financial institution sponsors a polo team or high level equestrian participant at special venues and in strategic equestrian events. 1101.1.

The intermediary organizes and manages the Polo Team Sponsorship and/or the high level equestrian precipitant sponsorship. Via the intermediary and the Equestrian Wealth Management Program implementation by participating in Real Polo at various strategic events and venues provides financial institution with a participatory status, a colleague faø ade, and a non-commercial presence in the Polo Community which then transcends and is transferable to the Dressage Community and Jumping Community 1101.2.

The financial institution sponsors a polo team at special venues and in strategic equestrian events. Similarly, the financial institution sponsors a leading participant in the dressage/jumping disciplines. With the qualified intermediary as the bridge-equestrian market access point, the financial institution is transformed from a commercial outsider to an insider becoming a peer participant. Sponsorship of a participating polo team is transferable to the other equestrian disciplines of dressage and jumping.

As a professional polo team sponsor which bears the name of the financial institution organized by intermediary, the targeted Global Equestrian Community participant, which client prospect, readily receives the financial institution and does not perceive the financial institution as a commercial intruder. Via intermediary and the polo team participation, the financial institution is enabled to establish a friend, trust, relationship is materially enhanced and is non-commercial. It is then possible to evolve the relationship from known person to friend to trust to private banking-wealth management relationship 1101.3.

1111 With the advice an assistance of the intermediary 1113, the financial institution will manage the financial assets of the prospect clients from the Global Equestrian Community, 1112, (Polo, Dressage, Jumping) 1112.1, 1112.2, 1112.3.

As a result of the strategic alliance, intermediary and the financial institution will have joint activities, 1120, the selection and processing of the Polo Teams-high level equestrian participants, sponsorships and venues, 1130, 1140, the private bankers and the financials institutions Global Office integration into the Polo Team Branded and high level equestrian participant Events, 1150, the prospect-client development from the Global Equestrian Community Disciplines, 1160, and the maintenance and development of prospects-clients and clients accounts derived from the implementation of the Equestrian Wealth Management Program in the Global Equestrian Community, 1170.

The specification and examples provided above should be considered exemplary only. It is contemplated that the appended claims will cover any other such embodiments or modifications as fall within the true scope of the invention.

What is claimed is:

1. A method to develop new prospects and clients, and to maintain and manage clients and their business derived from the Global Equestrian Community by global financial institutions offering private banking, wealth management services and other financial advisory services for the ultra high net worth and high net worth individuals, families, and related business entities within the four participating categories in the Equestrian Wealth Management Program (“Equestrian Wealth Management Program”) in a cost efficient and competitively enhanced manner, the method comprising the steps of:
(a) Providing, for financial institutions, an efficient, competitively enhanced and cost effective method to develop, to maintain, and to manage, via the intermediary established in the global Equestrian Community and the strategic global polo team sponsorships and/or high level equestrian participant sponsorship, prospects and clients and their related businesses derived from the Global Equestrian Community (Polo, Dressage and Jumping) described as the Equestrian Wealth Management Program.
(b) Identifying and accessing in a meaningful manner new prospects and clients derived from the Global Equestrian Community and development and maintenance of these prospects and clients and their related businesses via an intermediary established in the Global Equestrian Community and creating a peer participant and insider status in the Global Equestrian Community for the financial institution.
(c) Causing a material reduction in the cost and enhancement in the efficiency and effectiveness of the new prospect and client identification, access and development utilizing the intermediary and the intermediary's implementation of the Equestrian Wealth Management Program to facilitate development of prospects and clients and the retention and manage of their businesses.
(d) Causing the time consumption and effectiveness of the financial institution and private bankers to be more effectively and efficiently utilized, via the intermediary, (access provider to and organizer of the Global Equestrian Community), who directs the private bankers to attend events, organize events, meet prospects, meet clients, and otherwise access Global Equestrian Community in a structured, efficient, effective manner via the global polo team sponsorships and/or the high level equestrian participant sponsorship rather than a random, commercial approach.
(e) Creating a participating equestrian peer status and insider status for the financial institution through the established intermediary as a bridge and equestrian market access point to the Global Equestrian Community (Polo, Dressage, Jumping) and through the polo team sponsorship and high level equestrian participant sponsorship and the intermediary's implementation of the Equestrian Wealth Management Program.
(f) Providing, via the intermediary, the financial institution with an insider status from the perception of existing financial institution clients and the social participants in the Global Equestrian Community and providing a unique enhanced existing client entertainment destination for “behind the scenes” participation as an insider in a rarified elite, extreme equestrian sport for the purpose of identifying, accessing, developing, maintaining and managing prospects and clients and their businesses.
(g) Providing private banking, wealth management services and other financial services to prospects and clients and their businesses derived from the Global Equestrian Community Participants via the intermediary and the intermediary's implementation of the Equestrian Wealth Management Program as a front end or virtual equestrian bank, so that the traditional barriers to prospect/client identification, access, and development and are either eliminated or reduced to the minimum. This status and the classification of the role of the intermediary elevates the financial institution to a peer participant status and an insider status in the global Equestrian Community and acts as a competitive barrier to entry to other competitors attempting to access members the Global Equestrian Community

2. The method of claim 1.(a), wherein financial institutions provide private banking and wealth management and other financial services derived from and to ultra wealthy and high net worth individuals, families, and their businesses within the four participating categories in the Equestrian Wealth Management Program: 1) Equestrian Professionals, 2) High Level Patrons, 3) High Net Worth (“HNW”) Patrons and 4) Social-Access Participants.
For financial institutions, the two most inefficient and expensive business development activities are: 1) identifying qualified prospects and clients, and 2) accessing the identified qualified prospects and clients in a meaningful, efficient and effective manner with a high probability of success that the prospect becomes a meaningful client in a timely manner.

3. The method of claim 1.(a), wherein the Equestrian Wealth Management Program provides a deliberate, systematic, Business Method that either eliminates or minimizes to the fullest extent possible these two business and financial inefficiencies/ineffectiveness incurred by the financial institution.
The Equestrian Wealth Management Program provides a method, via a participating intermediary established in the Global Equestrian Community, to identify and to access in a meaningful, efficient and effective manner qualified private banking, wealth management and other financial services, prospects and clients in the Global Equestrian Community for the financial institution.

4. The method of claim 1.(a), wherein the intermediary has a non-commercial, historical presence in the Global Equestrian Community and in the private banking sector and is, effectively, the bridge, for the financial institutions that desire to cultivate and to attract the Global Equestrian Community participants as prospects and as clients and to manage and maintain their business in a unique tripartite manner.
The intermediary does so by participating in the equestrian event as a playing polo team member, organizing the polo team sponsorship by the financial institution, and by creating a strategic presence of the financial institution in the global Polo Community and/or with financial institution sponsorship of a qualified high level equestrian participant.

5. The method of claim 1(a), includes accessing the Global Equestrian Community, composed of three primary equestrian disciplines of Polo, Dressage and Jumping.
At the highest level, the individual patron and sponsor participants annually spend hundreds of thousands of dollars or millions of dollars in operating expenses to participate in equestrian activities on a global basis and spend millions of dollars on supporting capital expenditures on horses, real estate, stables and similar items—often times in multiple locations for local seasonal activities.
At the global level, each of the defined Global Equestrian Communities participant categories are (by definition) qualified candidates for high level private banking, wealth management services and other financial services.
As a result, the large amounts of money spent by financial institutions to attempt to identify categories of qualified prospects and clients is eliminated or minimized. Accessing individual participants in the Global Equestrian Community in a meaningful manner is difficult and the Equestrian Wealth Management Program eliminates or minimizes this barrier.

6. The method of claim 1.(b), wherein the Equestrian Wealth Management Program provides a method, via a participating intermediary established in the Global Equestrian Community, to identify and to access in a meaningful, efficient and effective manner qualified private banking, wealth management and other financial services prospects and clients in the Global Equestrian Community for the financial institution.

7. The method of claim 1.(c), wherein nowadays, financial institutions providing private banking, wealth management and other financial services have scores of private bankers traveling the world seeking to identify new prospects, and clients in an organized but somewhat random process that uses the law of averages to succeed. It is extremely inefficient, unproductive and expensive.
The Equestrian Wealth Management Program eliminates or minimizes to the fullest extent possible these business and financial inefficiencies/ineffectiveness incurred by the financial institution.

8. The method of claim 1.(c), wherein via the intermediary and the implementation of the Equestrian Wealth Management Program, the time of the financial institution through its private bankers is more efficient utilize. To effectively and efficiently implement the Equestrian Wealth Management Program there must be a significant integration between the intermediary, the financial institution and its private bankers.

9. The method of claim 1.(d) wherein the intermediary has the responsibility for providing the financial institution an anchor access to the Global Equestrian Community, to Polo venues and events. It also has to organize and manage the Global Polo Team activities, implement the Equestrian Wealth Management Program, identify and provide access to select targeted qualified candidates of the Global Polo Community for Wealth Management, manage and coordinate private banker's access and use of the Equestrian Wealth Management Program, and assist in the designated Bank alignment and branding with Real Polo.

10. The method of claim 1.(d) wherein via the intermediary, the financial institution, through its Offices near Equestrian Event venues, has special access opportunities to venue location and Equestrian Community participants. The financial institution also has access opportunities to the Equestrian Community participant at their base location. The time of the financial institution and private bankers is more effectively and efficiently utilized.
With the advice an assistance of the intermediary, the financial institution will manage the financial assets of the prospect-clients from the Global Equestrian Community, (Polo, Dressage, Jumping) in an efficient and timely tripartite manner and with an enhanced competitive status

11. The method of claim 1.(e) wherein with the intermediary as a bridge and equestrian market access point, the financial services provider essentially becomes an equestrian participant on the same level as the prospect and client and in essence acquires a participating equestrian peer status and insider status the same as the equestrian participant who is the targeted private banking/wealth management prospect and client. In this manner, the private banking and wealth management service provider is not viewed as a commercial participant but as a peer participant and insider.

12. The method of claim 1.(e), wherein the intermediary does so by participating in the equestrian event as a playing polo team member, organizing the polo team sponsorship by the financial institution, and by creating a strategic presence of the financial institution in the global Polo Community and/or with sponsorship of a qualified high level equestrian participant.

13. The method of claim 1.(e) wherein the Global Equestrian Community Participants perceive the financial institution as a key participatory supporter of the equestrian sport/discipline, and is open to listening to or is attracted to reciprocate and to become a prospect-client of the financial institution.
In addition, the financial institution will provide polo team sponsorships and/or high level equestrian participants in key competitive events, charity fund raising and exhibition equestrian polo events, create an extremely high profile, allegiance with leading (effectively an endorsement) of equestrian, business, financial, royalty, and celebrity persons which further enhances the trust factor and peer participant factor and insider factor with the targeted Global Equestrian Community Participants.

14. The method of claim 1.(f), wherein with the qualified intermediary as the bridge and equestrian market access point, the financial institution is transformed from a commercial outsider to an insider essentially becoming a peer participant on the same participatory level as the client prospect and in essence sits on the same sport bench as the equestrian participant who is the targeted private banking-wealth management prospect/client. This also provides the financial institution a unique enhanced existing client entertainment destination for “behind the scenes” participation as an insider in a rarified elite, extreme equestrian sport.
The traditional barriers to access (able to make appointment, unable to access the person, cold office environment, plethora of advisors to navigate, etc.) to the client prospect do not exist or are minimized.
This status and the classification of the role of the intermediary elevates the financial institution status in the global Equestrian Community and acts as a competitive barrier to entry to other competitors attempting to access members the Global Equestrian Community.
The involvement of the financial institution as a polo team sponsor or dressage participant sponsor and involvement with the Equestrian Professional, the High Level Patrons, and the HNW Patrons is a major attraction to the Social—Access Participant category and provides a similar authenticity, credibility, and anchor to the financial institution.
The Social—Access Participants perceives the financial institution to be an insider or have a peer participant status that the Social—Access Participant Category want to emulate and align with creating a prospect—client relationship for private banking-wealth management services.

15. The method of claim 1.(g), wherein the financial institution is able to provide services to the client, derived from the Global Equestrian Community via the Business Method, by three distinct integrated categories of service providing: 1) location of prospect—client at equestrian events at global equestrian venues 2) location of client (multi-season or permanent location) derived from the Global Equestrian Community which is typically different from equestrian venue; and 3) location of the assets and/or the desired location of the global assets as requested by the client derived from the Equestrian Community.

16. The method of claim 1.(g) wherein for the generation of new prospects-clients, it is necessary to create a strategic alliance between the intermediary and the financial institution, a strategic alliance for intermediary to be a front end or virtual equestrian bank for the financial institution in accruing and developing the private banking, wealth management and other financial advisory services opportunities in the Global Equestrian Community.

17. The method of claim 1.(g), wherein the services comprise a plurality of asset location services; private banking-wealth management services; investment management services; investment banking services; banking services; financial investment services; managing financial assets services; management and other services related to closely held stock services; international trusts services; real estate service; public relations services; crisis management services; and other banking services.
